(19) United States
(12) Patent Application Publication
(10) Pub. No.: US 2012/0182238 A1
(43) Pub. Date: Jul. 19, 2012

(54) METHOD AND APPARATUS FOR RECOGNIZING A PEN TOUCH IN A DEVICE

(75) Inventor: Kyung Ryol LEE, Suwon-si (KR)

(73) Assignee: SAMSUNG ELECTRONICS CO. LTD., Suwon-si (KR)

(21) Appl. No.: 13/348,858

(22) Filed: Jan. 12, 2012

(30) Foreign Application Priority Data
Jan. 14, 2011 (KR) 10-2011-0003931

(51) Int. Cl. G06F 3/041

(52) U.S. Cl. 345/173

(57) ABSTRACT

A method and device for distinguishing between a pen touch and a palm touch are provided. The device removes an input according to the palm touch, and processes only the pen touch as an effective input with a touch screen, thereby increasing the recognition of the pen touch. The method includes detecting an input touch, distinguishing between a pen touch and a palm touch, removing an input corresponding to the palm touch and processing an input corresponding to the input pen touch as an effective input, and controlling an operation corresponding to the pen touch.

### PRIORITY

This application claims the benefit under 35 U.S.C. §119(a) of a Korean patent application filed on Jan. 14, 2011 in the Korean Intellectual Property Office and assigned Serial No. 10-2011-0003931, the entire disclosure of which is hereby incorporated by reference.

### BACKGROUND OF THE INVENTION

1. Field of the Invention

The present invention relates to devices with touch screens. More particularly, the present invention relates to a method that removes an input according to a palm touch and processes only a pen touch as an effective input, in an environment where the pen touch and the palm touch are simultaneously applied to a touch screen, thereby increasing the recognition of the pen touch.

2. Description of the Related Art

With the rapid development of information and communication technology and semiconductor technology, the use of various types of mobile devices has increased. Mobile devices utilize mobile convergence to provide a variety of functions. These functions are related to various types of input and output modes. Output modes employ output devices such as display units or speakers. Input modes employ input devices, such as key buttons or touch interfaces.

Touch interfaces may be implemented in such a manner that display mobile devices display buttons, so that the users can interactively and intuitively operate the mobile devices by touching the button via their fingers or input tools, e.g., stylus pens, etc. A representative example of the touch interfaces is a touch screen that is popular in mobile devices. When the touch interfaces were initially developed, they allowed for only a single touch to create the input signal. Mobile devices with earlier developed touch interfaces may only be operated by a single touch gesture. As technology of touch interfaces developed, touch interfaces allowed for multi-touches by combining at least one touch gesture. Mobile devices with recent touch interfaces have been operated by various types of touches.

Touch screens installed in mobile devices perform a display function and an input function. A touch screen includes a display panel and touch sensors arrayed thereon. Touch screens detect contacts or touches of the users' fingers or touch pens (e.g., stylus pens, etc.) via the touch sensors.

On touch screens supporting a multi-touch function, a user's intended touch and an unintentional touch may occur simultaneously. For example, when a user performs a function on the touch screen via an input tool, such as a touch pen, etc. while the user's hand is on the touch screen, the touch screen cannot detect a correct location of a touch by the input device (for example, if the touch is performed via a touch pen, it is called a pen touch) because an unintentional touch by the hand (e.g., a palm touch) occurs. As a result, the user cannot perform the intended function on the touch screen.

Accordingly, there is a need for a method and apparatus to correctly recognize only a user's intended pen touch and to perform a corresponding operation.

### SUMMARY OF THE INVENTION

Aspects of the present invention are to address at least the above-mentioned problems and/or disadvantages and to provide at least the advantages described below. Accordingly, an aspect of the present invention is to provide a pen touch recognizing method and apparatus that can identify a user's intended pen touch and an unintentional palm touch that are applied to a touch screen.

Another aspect of the present invention is to provide a pen touch recognizing method and apparatus that can process, when a palm touch and a pen touch are simultaneously applied to a touch screen, the pen touch as an effective input.

Another aspect of the present invention is to provide a pen touch recognizing method and apparatus that can identify a palm touch and a pen touch, simultaneously applied to a touch screen, remove the input corresponding to the palm touch according to the degree of matching between information regarding the identified palm touch and preset palm touch, recognize the input via the pen touch as an effective input, and process the corresponding operation.

Another aspect of the present invention is to provide a method and apparatus that can achieve an optimal environment in a device where a user's intended pen touch can be easily recognized, thereby increasing the use convenience of the device.

In accordance with an aspect of the present invention, a method for recognizing a pen touch in a device with a touch screen is provided. The method includes detecting an input touch, distinguishing between a pen touch and a palm touch, removing an input corresponding to the palm touch and processing an input corresponding to the pen touch as an effective input, and controlling an operation corresponding to the pen touch.

The method may further include setting a palm touch identifying reference value with respect to the palm touch before the detecting of the input touch. Distinguishing between the pen touch and the palm touch may includes identifying the palm touch and the pen touch with respect to the input touch, calculating a palm touch value according to the identified palm touch, comparing the calculated palm touch value with the palm touch identifying reference value, and removing an input corresponding to the palm touch according to a degree to which the calculated palm touch value matches the palm touch identifying reference value.

Comparing the calculated palm touch value with the present palm touch identifying reference value may includes producing pattern information indicating the degree to which the calculated palm touch value matches the palm touch identifying reference value, and determining whether the pattern information is equal to or greater than a palm touch invalidating reference value. The method may further include recognizing an input via the palm touch area as the palm touch, when the pattern information is equal to or greater than a preset palm touch invalidating reference value, and processing and removing the input corresponding to the recognized palm touch as an ineffective input. The method may also include receiving, when the pattern information is less than a palm touch invalidating reference value, inputs via the palm touch area corresponding to the palm touch until the pattern information is equal to the palm touch invalidating reference value, storing the received inputs, and deleting, when the pattern information is equal to the palm touch invalidating reference value during the storage of the received inputs, the temporarily stored inputs corresponding to the palm touch.

Identifying the palm touch and the pen touch may includes identifying a palm point and a pen point with respect to the input touch, recognizing the pen point as the pen touch, and recognizing the palm point as the palm touch. Calculating a palm touch value may includes setting a palm touch area based on areas corresponding to the palm point, and calculating the palm touch value using the set palm touch area.

The pen touch recognizing method may be implemented with programs that can be executed by a processor, which are stored in a computer-readable recording media.

In accordance with another aspect of the present invention, a device with a touch screen is provided. The device includes a storage unit and a controller. The storage unit stores a palm touch identifying reference value that is set as a reference value to identify a palm touch and a palm touch invalidating reference value that is set as a reference value to invalidate the input of the palm touch. The controller identifies a pen touch and a palm touch that are simultaneously input, and removes an input corresponding to the palm touch. The controller processes only the pen touch as an effective input, and controls an operation corresponding to the pen touch.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a schematic block diagram of a device according to an exemplary embodiment of the present invention;

FIG. 2 illustrates a flowchart of a method for setting a palm touch identifying reference value in a device according to an exemplary embodiment of the present invention;

FIG. 3 illustrates views of an interface to describe a process of setting a palm touch identifying reference value in a device according to an exemplary embodiment of the present invention;

FIGS. 4 to 6 illustrate screens to describe a process of creating a palm touch identifying reference value in a device according to an exemplary embodiment of the present invention;

FIG. 7 illustrates a flowchart of a method for recognizing a pen touch in a device according to an exemplary embodiment of the present invention;

FIG. 8 illustrates a flowchart of a method for identifying a pen touch and a palm touch in a device according to an exemplary embodiment of the present invention; and

FIG. 9 illustrates a screen to describe a method for identifying a pen touch and a palm touch in a device, according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention is provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention relate to devices with touch screens. The devices distinguish between a palm touch and a pen touch applied to the touch screens and process only the input of the pen touch as an effective input, ignoring the input of the palm touch. Accordingly, the devices can increase the recognition of a pen touch in the touch screen.

In the following exemplary embodiments, the touch screens installed in the devices support a multi-touch function. The touch screens may be implemented with a capacitive type touch screen. The term ‘palm touch’ denotes an unintentional touch that occurs on the touch screen while the user performs a function via his/her finger or an input tool such as a touch pen. The term ‘pen touch’ denotes a user's intended touch when the user conducts a function via his/her finger or an input tool. For example, when a user performs a function on the touch screen via an input tool such as a touch pen, etc. while the user's hand is on the touch screen, the user's unintentional touch may occur on the touch screen, and, in that case, this touch corresponds to the palm touch described above. The user's intended touch corresponds to the pen touch.

In the following description, the configuration of the device and the method for controlling the device are explained in detail referring to the accompanying drawings. It should be understood that the invention is not limited to the following embodiments, and many modifications may be made.

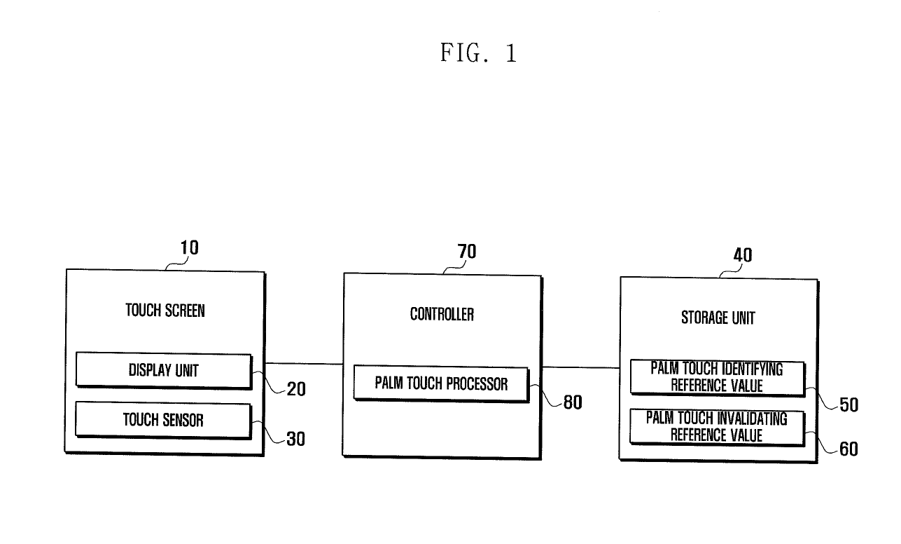

FIG. 1 illustrates a schematic block diagram of a device according to an exemplary embodiment of the present invention.

Referring to FIG. 1, the device includes a touch screen 10, a storage unit 40, and a controller 70. Although it is not shown in the drawings, the device may further include an audio processing unit with a microphone and a speaker, a digital broadcast module for receiving and playing back mobile broadcasting (e.g., Digital Multimedia Broadcasting (DMB), Digital Video Broadcasting (DVB), etc.), a camera module for photographing pictures/video, a Bluetooth communication module, a communication module for supporting a mobile communication service, an Internet communication module, a touchpad, an input unit for supporting a key input function, a battery for supplying electric power to the components described above, etc. Since these elements are well-known to an ordinary person skilled in the art, a detailed description is omitted in the following description.

The touch screen 10 includes a display unit 20 and touch sensors 30.

The display unit 20 displays the states when the device operates and data related to the operations. The display unit 20 displays a home screen and screens when applications are executed in the touch device. The applications execute a variety of functions, such as a message function, an email function, an Internet function, web-browsing, communication, an e-book function, photographing, a video function, playing back photographs/video, mobile broadcasting, audio playback, a game function, etc. The display unit 20 also displays content (e.g., photographs, images, list, text, icons, menus, etc.) under the control of the controller 70. The display unit 20 switches content according to touch events detected by the touch sensors 30, and displays the content under the control of the controller 70.

The display unit 20 may be implemented with a Liquid Crystal Display (LCD), an Organic Light Emitting Diode (OLED), an Active Matrix Organic Light Emitting Diode (AMOLED), or the like. The display unit 20 may display execution screens in a landscape mode or portrait mode according to the rotation direction of the touch device.

The touch sensors 30 detects touches that are applied to the touch screen 10 by the user's finger or an input tool such as a touch pen or a stylus pen. The touch sensors 30 detect a coordinate corresponding to an area where a touch is detected and transfer the coordinate to the controller 70. When the user performs a gesture on the touch screen 10, for example, a touch, a drag, a tap, etc., the touch sensors 30 detect the user's applied gesture, i.e., a touch.

Although the touch sensors 30 are described as capacitive overlay sensors that detect input touches by detecting the change in capacitance, the touch sensors 30 may also be implemented with various types of sensors. For example, the touch sensors 30 may be resistive overlay types of sensors that detect input touches by detecting a change in resistance. The touch sensors 30 may also be piezoelectric sensors that can detect input touches by measuring pressure and converting it to an electrical charge. The input touches may be created by various types of gestures detected by the touch sensors 30, for example, touch, touch movement (e.g., drag, move, etc.), touch and release (e.g., a tap), etc.

The storage unit 40 stores programs executed in the device and data created as the programs are executed. The storage unit 40 is implemented with at least one non-volatile memory device and volatile memory device or a combination thereof Examples of the non-volatile memory device are Read Only Memory (ROM), flash memory, etc. The volatile memory device includes a Random Access Memory (RAM), etc. The storage unit 40 temporarily or permanently stores an Operating System (OS) of the device, data and programs related to the display control operations of the display unit 20, data and programs related to the input control operations of the touch sensors 30, data and programs that can distinguish a palm touch and a pen touch on the touch screen 10, remove an input corresponding to the palm touch, and process only the pen touch as an effective input, etc.

The storage unit 40 also stores a palm touch identifying reference value 50 used to identify a palm touch that is unintentional in a touch input mode, and a palm touch invalidating reference value 60 used to process an input of a palm touch as an ineffective input. The palm touch identifying reference value 50 may have at least one or more values to enhance the recognition of a user's intended pen touch in a touch input mode. The palm touch identifying reference value 50 may be set according to the user or the device manufacturer. The setting methods and usages of the palm touch identifying reference value 50 of the palm touch invalidating reference value 60 will be described later.

The controller 70 controls the operations and states of the device. When the controller 70 simultaneously receives a palm touch and a pen touch, the controller 30 processes the palm touch as an ineffective input, and only the pen touch as an effective input, thereby enhancing the recognition of pen touch. For example, the controller 70 may allow the user to set a palm touch identifying reference value 50 in a palm touch setting mode. The controller 70 may detect at least one input touch via the touch sensors 30 in a writing input mode. The controller 70 may identify whether an input touch is performed by a pen touch or a palm touch, or simultaneously performed by both. The controller 70 may process the palm touch as an ineffective input, and only the pen touch as an effective input. Accordingly, the controller 70 increases the recognition of pen touch, so that the controller 70 correctly processes only the user's intended touch.

The controller 70 identifies whether an input touch is a pen touch or a palm touch, and calculates a value of the identified palm touch, i.e., a palm touch value. The controller 70 compares the calculated palm touch value with the palm touch identifying reference value 50. When the controller 70 ascertains that the difference (degree of consistence; corresponding to pattern information) between the calculated palm touch value and the palm touch identifying reference value 50 is equal to or greater than the palm touch invalidating reference value, the controller 70 processes the palm touch as an ineffective input. In that case, the controller 70 recognizes only the pen touch and processes the pen touch as an effective input.

The controller 70 identifies an area where an input touch is created via the touch sensors 30 and determines whether the input touch is a palm touch or a pen touch. The controller 70 processes the palm touch as an ineffective input and the pen touch as an effective input. The controller 70 includes a palm touch processor 80 to perform the processing.

As described above, the controller 70 identifies a palm touch and a pen touch that are simultaneously applied to the touch screen 10, processes only the pen touch according to a user's intended gesture as an effective input, and displays contents corresponding to the user's intended pen touch (e.g., text) on the touch screen 10. The control operations of the controller 70 are described below.

The controller 70 also controls the operations related to the usual functions of the device. For example, when the controller 70 executes an application, the controller 70 may control the operations and display corresponding data. The controller 70 receives input signals according to a variety of input modes that the touch-based input interface supports, and controls corresponding functions. The controller 70 may also control the transmission/reception of data based on wired or wireless communication.

The device as shown in FIG. 1 may be any type of electronic device with a touch screen, including an information communication device, a multimedia device, and their applications, which are operated according to communication protocols corresponding to a variety of communication systems. For example, the device may be a mobile communication terminal, a tablet personal computer, a smartphone, a Portable Multimedia Player (PMP), a digital broadcast player, a Personal Digital Assistant (PDA), a mobile game player, etc. In addition, the method for enhancing the recognition of pen touch by removing a palm touch may be adapted to monitors, laptop computers, televisions, Large Format Displays (LFDs), Digital Signage (DS), media poles, etc.

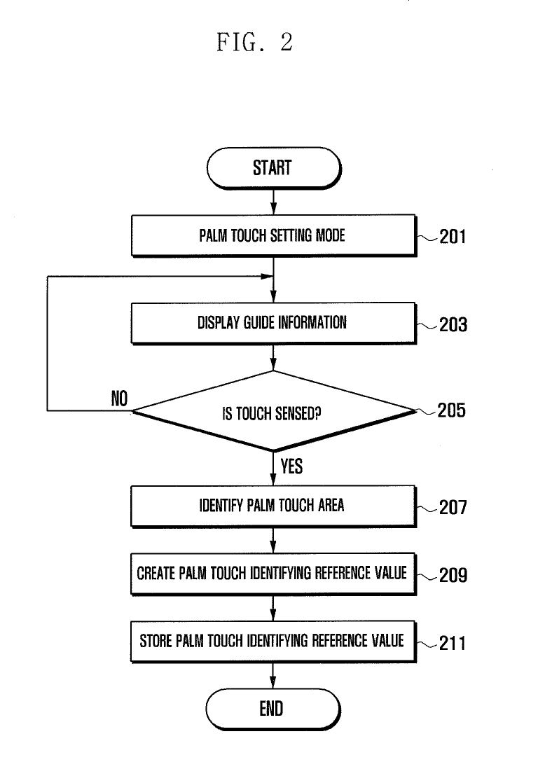

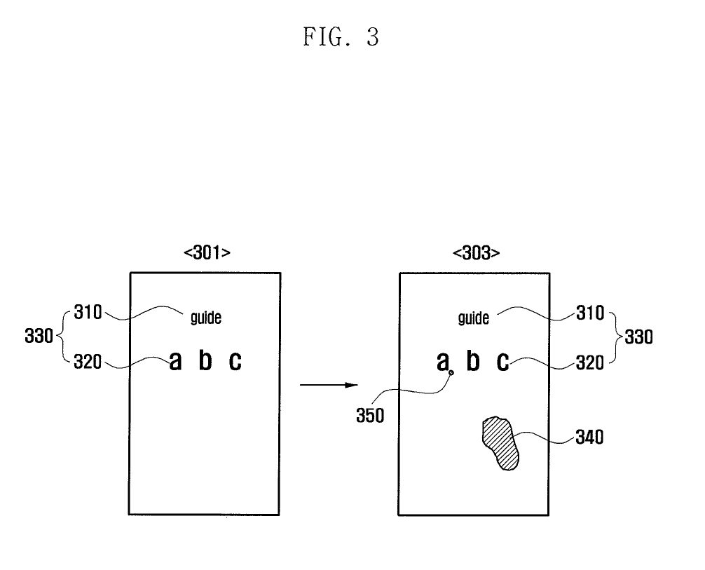

FIG. 2 illustrates a flowchart that describes a method for setting a palm touch identifying reference value in a device, according to an exemplary embodiment of the present invention. FIG. 3 illustrates views of an interface to describe a process of setting a palm touch identifying reference value in a device, according to an exemplary embodiment of the present invention.

Referring to FIGS. 2 and 3, the controller 70 executes a palm touch setting mode in response to a user's request at step 201. The controller 70 displays guide information on the screen in the palm touch setting mode at step 203. This is shown in diagram 301 of FIG. 3.

As shown in diagram 301, the controller 70 displays guide information 330 on the display unit 20 that includes a guide message 310 and sample information 320. The guide message 310 may be a notice that guides a method for managing a palm touch setting mode, for example, stating “Please write the following content via the input tool!” The sample information 320 may be content shown in the guide message 310, for example, text (e.g., the user's native language, English), diagrams (e.g., circle, rectangle, triangle), etc. The sample information 320 is used to analyze a pattern of a user's input pen touches and a pattern of palm touches that are input simultaneously when pen touches are input.

After displaying the guide information 330 at step 203, the controller 70 determines whether a touch is input at step 205. For example, the controller 70 determines whether a touch is detected via the touch sensors 30. When the controller 70 ascertains that a touch is not detected via the touch sensors 30 at step 205, the controller 70 returns to step 203 where the controller 70 displays the guide information 330 or terminates the palm touch setting mode according to a user's request.

When the controller 70 ascertains that a touch is detected by the touch sensors 30 at step 205, the controller 70 identifies an area where the palm touch has been input at step 207. The controller 70 creates a palm touch identifying reference value for the palm touch area at step 209. This is shown in diagram 303 of FIG. 3.

As shown in diagram 303, the user may apply a palm touch and a pen touch via by holding an input tool (e.g., a touch pen) at a certain angle with respect to the touch screen 10. For example, the user may input a palm touch and a pen touch at a usual hand writing posture. The user may create a pen touch by applying the input tool to a particular single point 350 on the sample information 320 (e.g., the letter ‘a’). Simultaneously, a palm touch may also be created by the other part of the user's hand according to the user's hand writing posture with respect to the contact point of the input tool. The oblique line area 340 is an area where the user's palm touch is created, hereinafter called a palm touch area. When the user writes in a usual hand writing posture, the palm touch and the pen touch are typically performed separately from each other, and the area where the palm touch is created (i.e., palm touch area 340) is greater than the area where the pen touch is created. A single point 350 to which the pen touch is applied is called a pen point. Likewise, the palm touch area 340 to which the palm touch is applied includes multiple points where a number of points are crowded, and these are called palm points.

The palm touch area 340, a type of palm touch, includes a group of points. The pen point 350 as a contact point, separated from the palm touch area 340, may be detected as a pen touch candidate. The controller 70 may identify a palm touch via the palm touch area 340 formed by a group of points, and calculate a palm touch identifying reference value based on the palm touch area 340.

The palm touch identifying reference value may be calculated by using the size of the palm touch area 340, the number of contact points detected in the palm touch area 340 (i.e., the number of palm points), the distance between the center of the palm touch area 340 and the pen point 350, etc.

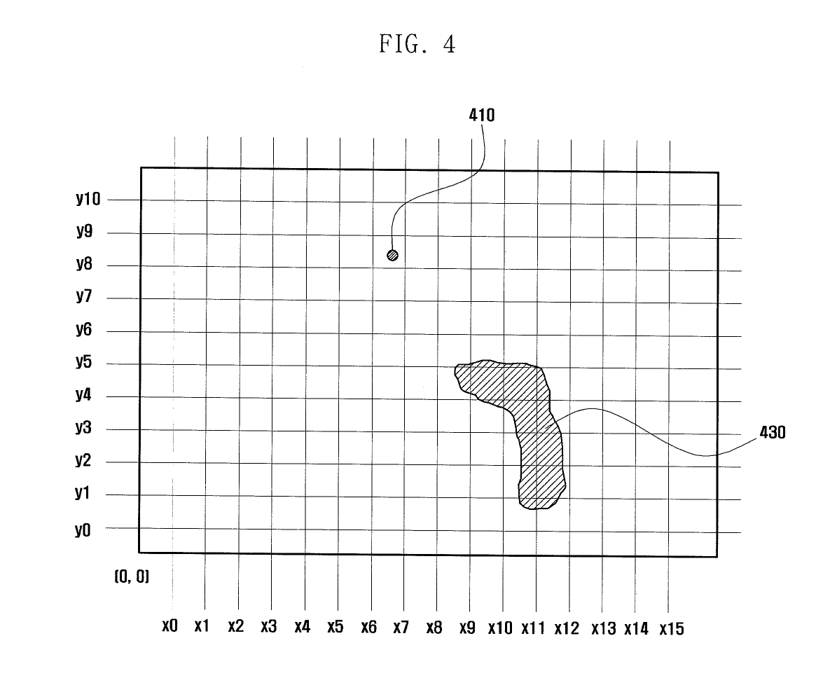

Since users may use touch screens in a slanted angle, the angles of using input tools (e.g., angles for gripping pens) may differ according to the users. This may result in producing various different types of palm touch areas 340. Accordingly, the respective palm touch areas 340 are different in their center points. When the respective palm touch areas have a number of center points, this results in a number of distances and angles between the center points and the pen points 350. This is described below referring to FIGS. 4 to 6.

FIG. 4 illustrates a touch screen that to describe a process of sensing a palm point by a palm touch and a pen point by a pen touch, according to an exemplary embodiment of the present invention.

Referring to FIG. 4, the user creates a pen touch and a palm touch by holding a pen on the touch screen 10, at a certain angle with respect to the touch screen 10. As described above, the pen touch and the palm touch are created separately from each other, and the area where the palm touch is created, i.e., palm touch area, is greater than the area where the pen touch is created, i.e., pen touch area. Accordingly, the palm touch area 430 may be expressed by a group of grid cells. A pen point 410, spaced apart from the palm touch area 430, may be detected as a pen touch candidate.

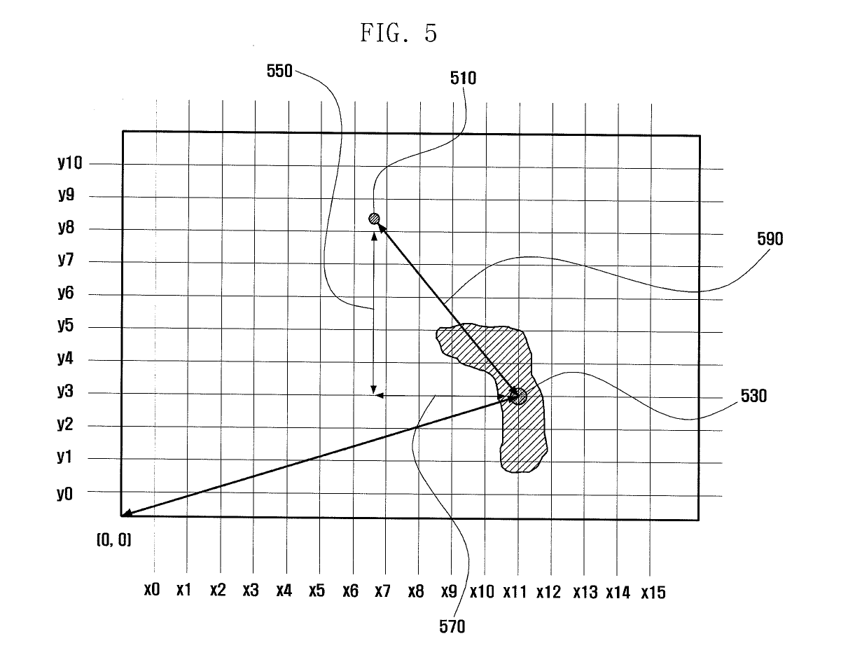

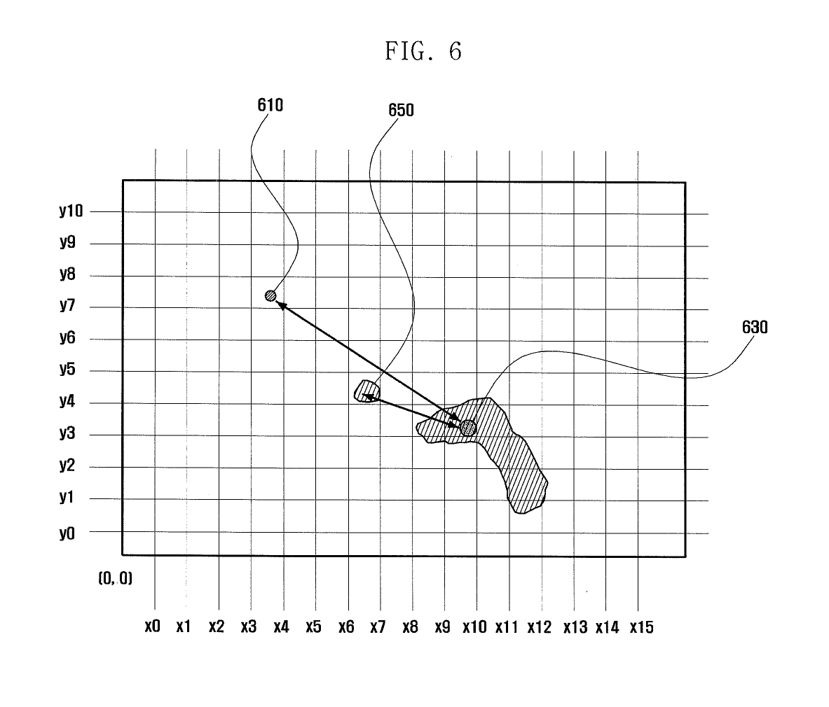

Identifying a pen point to recognize a pen touch may be performed by tracking a grid cell separated from the grid cells in the palm touch area 430 and by determining whether a contact point in a grid cell farthest from the palm touch area 430 is a pen point corresponding to a pen touch. A description of how to calculate a distance between the palm touch area 430 and the contact point in a grid cell farthest from the palm touch area 430 is described below referring to FIGS. 5 and 6.

FIGS. 5 and 6 illustrate touch screens to describe a method for calculating a distance between a palm point by a palm touch and a pen point by a pen touch according to an exemplary embodiment of the present invention.

Referring to FIG. 5, when the pen touch candidate and the palm touch area 430 according to a palm touch are determined as described above referring to FIG. 4, a calculation is made as to the coordinate of the center point 530 in the palm touch area 430. The center point 530 of the palm touch area 430, created by a palm touch on the touch screen 10, is determined by averaging the size of the palm touch area 430 and setting the average as a coordinate. The x-axis direction distance 570 and y-axis direction distance 550 are calculated from the center point 530 of the palm touch area 430 to the contact point 510 determined as a pen touch candidate. After that, the two vectors in x-direction 570 and y-direction 550 are added to produce a vector sum 590. The distance between the center point 530 of the palm touch area 430 and the contact point 510 is calculated by acquiring a scalar from the vector sum 590.

Referring to FIG. 6, there may be a number of palm touch areas according to a user's pen touch inputting postures. The coordinates of the center points of the palm touch areas according to all the pen touches are calculated respectively. For example, as shown in FIG. 6, the center point 630 of a palm touch area has a coordinate (x10, y4), the first contact point 610 spaced apart from the center point 630 has a coordinate (x4, y8), and the second contact point 650 spaced apart from the center point 630 has a coordinate (x7, y5).

The first contact point 610 is spaced apart from the center point 630 by 6 units in the x-direction and 4 units in the y-direction. The second contact point 650 is spaced apart from the center point 630 by 3 units in the x-direction and 1 unit in the y-direction. Considering all the distances in the x- and y-direction, the first contact point 610, the farthest distance from the center point 630, is determined as a pen point according to the pen touch, and the second contact point 650 is determined as a palm point according to a palm touch.

Referring to FIGS. 4 to 6, the pen touch and the palm touch are identified, and the area of a palm point corresponding to the identified palm touch is set as a palm touch area 340. The size of the set palm touch area 340, the number of palm points detected in the palm touch area 340, and the distance from the center point of the palm touch area 340 to a pen point 350 are calculated. The calculated values are used to calculate a palm touch identifying reference value 50.

Referring back to FIG. 2, the controller 70 stores the palm touch identifying reference value 50, created according to the user's pattern for the pen touch and palm touch, via the procedure described above, at step 211. The palm touch identifying reference value 50 may be provided to a user interface according to the user's request. The procedure may create and store a number of palm touch identifying reference values. The palm touch identifying reference values may be provided in a list. The palm touch identifying reference value 50 may be set as a default value when the device is manufactured. Alternatively, the palm touch identifying reference value stored in the device may be re-set according to a user's settings.

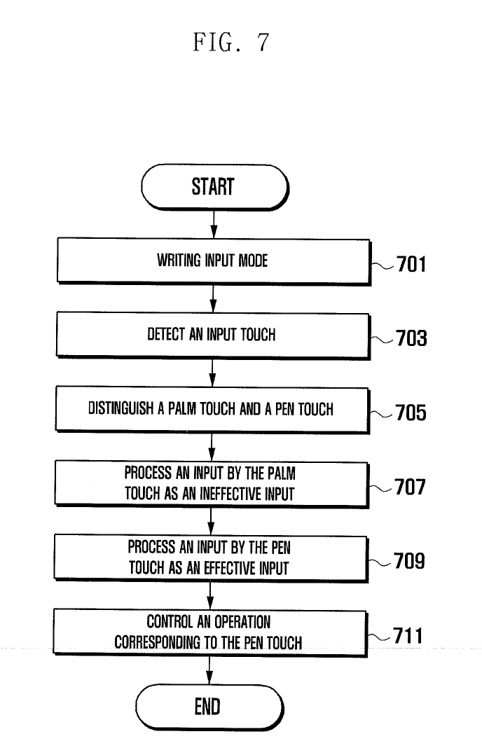

FIG. 7 illustrates a flowchart of a method for recognizing a pen touch in a device, according to an exemplary embodiment of the present invention.

Referring to FIG. 7, the controller 70 executes a writing input mode in response to a user's request at step 701. The controller 70 controls the display of a screen according to the execution of a writing input mode, and waits for a user's touch. Although the following exemplary embodiment will be described based on a writing input mode, it should be understood that exemplary embodiments of the present invention are not limited thereto. Exemplary embodiments of the present invention may be applied to other states where an unintended palm touch occurs in the touch-based device while writing letters, selecting menus, controlling scroll operations, etc., via an input tool.

After executing a writing input mode at step 701, the controller 70 detects a touch input to the screen at step 703. For example, when the user takes a writing input posture on the touch screen 10 (e.g., a posture where a palm touch and a pen touch are applied or only a pen touch is applied), the touch sensors 30 of the touch screen 10 detect the user's input touch according to the posture, create corresponding input signals, and transfer them to the controller 70.

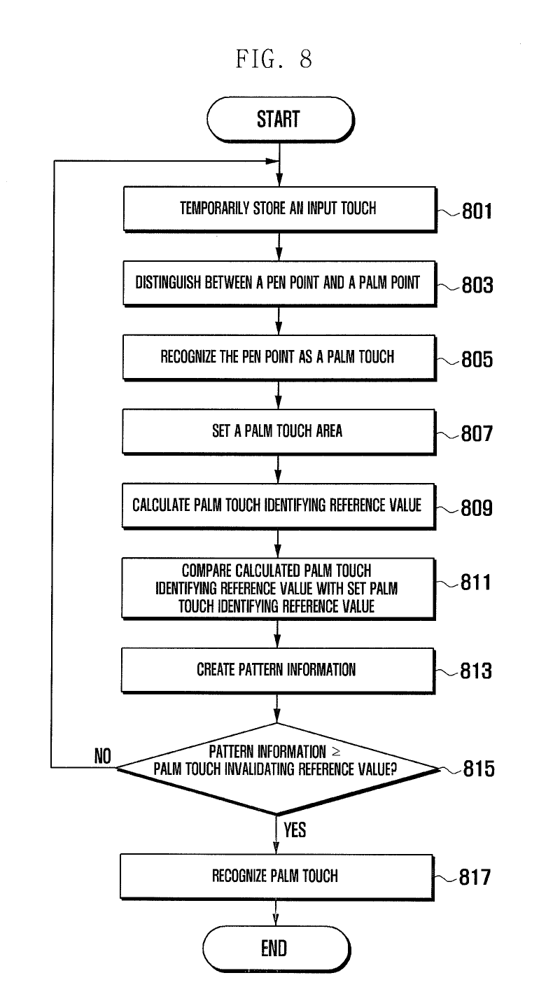

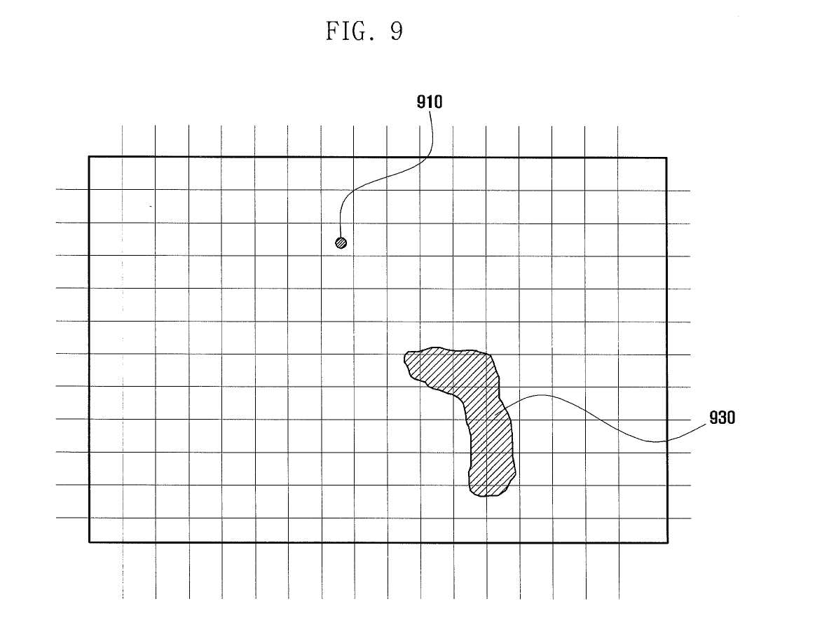

The controller 70 receives the user's input touches and identifies whether they are a pen touch or a palm touch at step 705. This operation will be described below referring to FIGS. 8 and 9.

The controller 70 processes the identified palm touch as an ineffective input at step 707. The controller 70 ignores the input signals corresponding to the palm touch, transferred from the touch sensors 30. The controller 70 processes the identified pen touch as an effective input at step 709. The controller 70 recognizes the input signals corresponding to the pen touch as effective inputs, transferred from the touch sensors 30.

The controller 70 controls the operations corresponding to the effective inputs according to the pen touch at step 711. For example, the controller 70 receives content (e.g., text, etc.) according to a pen touch and displays the content on the screen 10.

FIG. 8 illustrates a flowchart of a method for identifying a pen touch and a palm touch in a device, according to an exemplary embodiment of the present invention. FIG. 9 illustrates a screen to describe a method for identifying a pen touch and a palm touch in a device, according to an exemplary embodiment of the present invention.

Referring to FIG. 8, the controller 70 stores the user's input touch, detected at step 703 of FIG. 7, in a buffer at step 801. The controller 70 identifies a pen point and a palm point at step 803, and then recognizes the identified pen point as a pen touch at step 805.

For example, the palm touch may contact a larger area on the touch screen than the pen touch. When the user applies performs a touching operation on the touch screen via an input tool (e.g., a pen), the touch by a pen is likely to be applied to the touch screen, spaced apart from the palm touch. The controller 70 may distinguish between the palm touch and the pen touch from the difference between the sizes of contact areas by the pen touch and the palm touch and the distance between touch points.

When the controller 70 detects the touch, the controller 70 determines whether the input touch is performed by a pen creating one contact point, by the palm creating a group of points, or by both the pen and the palm. When the controller 70 identifies only a pen point, the controller 70 recognizes the input touch by the pen point as a pen touch. Likewise, when the controller 70 identifies only a palm point, the controller 70 recognizes the input touch by the palm point as a palm touch. In addition, when the controller 70 identifies both a pen point and a palm point, the controller 70 may distinguish between the pen point and the palm point, and recognize the input touch by the pen point as a pen touch and the input touches by the palm point as a palm touch. These processes are described below referring to FIG. 9.

FIG. 9 is a screen to describe a process of detecting a palm point by a palm touch and a pen point by a palm touch according to an exemplary embodiment of the present invention.

Referring to FIG. 9, in a usual writing posture, a palm touch, and a pen touch may be performed, spaced apart from each other. The palm touch area 930 is greater than the pen touch area 910. The palm points by a palm touch corresponds to a group of a number of grid cells on the touch screen 10. The controller 70 detects a contact point (i.e., pen point), spaced apart from a group of a number of points (i.e., palm points), as a pen touch candidate.

Users hold pens at different angles with respect to the touch screen. In order to identify a pen point for a pen touch, the controller 70 searches for independent touch grid cells and first determines a contact point, farthest from a palm point area, as a pen point candidate according to a pen touch. When the controller 70 ascertains that an input value (e.g., a contact resistance) at the pen point is greater than a threshold value, the controller 70 recognizes the input as a pen touch. When the controller 70 ascertains that an input value (e.g., a contact resistance) at the pen point is equal to or less than the threshold value, it detects that an effective pen touch is not input.

The controller 70 sets a palm touch area by using the identified palm point at step 807. The controller 70 calculates a palm touch identifying reference value by using the set palm touch area at step 809. For example, the controller 70 distinguishes between a pen touch by a pen point and a palm touch by a palm point, and then sets a palm touch area by using the areas corresponding to the palm point of the distinguished palm touch. The controller 70 calculates a palm touch identifying reference value by using the set palm touch area. For example, the controller 70 may calculate the size of the palm touch area, the number of palm points detected in the palm touch area, the distance from the center point of the palm touch area to a pen point, etc. The controller 70 calculates a palm touch identifying reference value by using the calculated values, such as the size of palm touch area, the number of palm points, and the distance.

The controller 70 compares the calculated palm touch value with a preset palm touch identifying reference value 50 at step 811, and then creates pattern information indicating the degree of consistency at step 813. The pattern information is expressed as a percentage (%).

The controller 70 compares the created pattern information with a preset palm touch invalidating reference value 60, i.e., determines whether the created pattern information is equal to or greater than a preset palm touch invalidating reference value 60 at step 815. The controller 70 determines whether the calculated palm touch value corresponds to a preset palm touch identifying reference value 50. When the controller 70 ascertains that the pattern information is equal to or greater than a certain percentage, the controller 70 recognizes the input touch as a palm touch and removes the input corresponding to the input touch.

When the controller 70 ascertains that the pattern information between the calculated palm touch value and the preset palm touch identifying reference value 50 is less than a preset palm touch invalidating reference value 60 at step 815, the controller 70 returns to step 801 where the controller 70 continues to receive and store input touches. The controller 70 continues receiving an input corresponding to a palm touch and temporarily stores the input. While doing this process, the controller 70 calculates a palm touch value and compares the calculated palm touch value with a preset palm touch identifying reference value 50 until the pattern information is equal to a palm touch invalidating reference value 60. When the identified palm touch does not match the preset pattern, the controller 70 continues receiving the inputs and temporarily stores the inputs. When the controller 70 analyzes corresponding pattern information until the last input touch and ascertains that the identified palm touch does not match the preset pattern, the controller 70 stores the information received. When the controller 70 ascertains that the pattern information matches the palm touch invalidating reference value 60, the controller 70 removes the input corresponding to the temporarily stored palm touch. This process is designed to remove an input of an unintentional touch that may be created when the pattern information does not match the value 60 from a time point when the user's palm first starts to contact the touch screen 10 to a time point when the entire palm contacts the touch screen 10.

When the controller 70 ascertains that the pattern information between the calculated palm touch value and the preset palm touch identifying reference value 50 is equal to or greater than a preset palm touch invalidating reference value 60 at step 815, the controller 70 recognizes the input touch, with respect to the preset palm touch area, as a palm touch at step 817. The controller 70 processes the palm touch, recognized at steps 707 and 709, as an ineffective input. The controller 70 processes only the pen touch as an effective input, and performs the corresponding operation.

Although not shown in the drawings, exemplary embodiments of the present invention may be modified in such a manner that, in an environment where a palm touch is applied to the touch screen when a pen touch is being applied to the touch screen, when the controller 70 ascertains that the pattern information is equal to or greater than the palm touch invalidating reference value 60 by performing a pattern analysis before the other input according to a palm touch is completely removed, the controller 70 removes the temporarily stored palm touch input.

As described above, the pen touch recognizing method and apparatus according to exemplary embodiments of the present invention may easily identify a user's intended touch (e.g., a pen touch) and an unintentional touch (e.g., a palm touch) that occur on a touch screen of a device. Accordingly, the method and apparatus enhances the reliability of creating input signals on the touch screen, and can allow users to correctly and rapidly conduct his/her intended function without error.

When the pen touch recognizing method that can remove inputs according to palm touches is adapted to all types of devices, the devices can achieve an optimal environment where a pen touch can be recognized with a high degree of recognition and provide high use convenience.

As described above, the method according to exemplary embodiments of the present invention enhances the pen touch recognition by removing inputs corresponding to palm touches and can be implemented with program commands that can be conducted via various types of computers and recorded in non-transitory computer-readable recording media. The non-transitory computer-readable recording media contain program commands, data files, data structures, or the like, or a combination thereof The program commands recorded in the recording media may be designed or configured to comply with the invention or may be software well-known to the ordinary person skilled in the art.

The non-transitory computer-readable recoding media includes hardware systems for storing and conducting program commands. Examples of the hardware systems are magnetic media such as a hard disk, floppy disk, a magnetic tape, optical media such as Compact Disc (CD)-ROM and Digital Versatile Disc (DVD), Magneto-Optical Media, such as floptical disk, ROM, RAM, flash memory, etc. The program commands include assembly language or machine code complied by a complier and a higher level language interpreted by an interpreter. The hardware systems may be implemented with at least one software module to comply with exemplary embodiments of the present invention.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for recognizing a pen touch in a device with a touch screen, the method comprising:
detecting an input touch;
distinguishing between a pen touch and a palm touch;
removing an input corresponding to the palm touch and processing an input corresponding to the pen touch as an effective input; and
controlling an operation corresponding to the pen touch.

2. The method of claim 1, further comprising:
setting a palm touch identifying reference value with respect to the palm touch before the detecting of the input touch.

3. The method of claim 2, wherein the distinguishing between the pen touch and the palm touch comprises:
identifying the palm touch and the pen touch with respect to the input touch;
calculating a palm touch value according to the identified palm touch;
comparing the calculated palm touch value with the palm touch identifying reference value; and
removing an input corresponding to the palm touch according to a degree to which the calculated palm touch value matches the palm touch identifying reference value.

4. The method of claim 3, wherein the identifying of the palm touch and the pen touch comprises:
identifying a palm point and a pen point with respect to the input touch;
recognizing the pen point as the pen touch; and
recognizing the palm point as the palm touch.

5. The method of claim 4, wherein the calculating of the palm touch value comprises:
setting a palm touch area based on areas corresponding to the palm point; and
calculating the palm touch value based on the set palm touch area.

6. The method of claim 5, wherein the calculating of the palm touch value comprises:
calculating values including a size of the palm touch area, a number of contact points detected in the palm touch area, and a distance between the center of the palm touch area and the pen point; and
calculating the palm touch value based on the calculated values.

7. The method of claim 3, wherein the comparing of the calculated palm touch value with the palm touch identifying reference value comprises:
producing pattern information indicating the degree to which the calculated palm touch value matches the palm touch identifying reference value; and
determining whether the pattern information is equal to or greater than the palm touch invalidating reference value.

8. The method of claim 7, further comprising:
recognizing an input via a palm touch area as the palm touch, when the pattern information is equal to or greater than the palm touch invalidating reference value; and
processing and removing the input corresponding to the recognized palm touch as an ineffective input.

9. The method of claim 7, further comprising:
receiving, when the pattern information is less than the palm touch invalidating reference value, inputs via a palm touch area corresponding to the palm touch until the pattern information is equal to the palm touch invalidating reference value;
storing the received inputs; and
deleting, when the pattern information is equal to the palm touch invalidating reference value during the storage of the received inputs, the stored inputs corresponding to the palm touch.

10. The method of claim 2, wherein the setting of the palm touch identifying value comprises:
displaying sample information for analyzing a pattern of the user's input.

11. A device with a touch screen, the device comprising:
a storage unit for storing a palm touch identifying reference value that is set as a reference value to identify a palm touch and a palm touch invalidating reference value that is set as a reference value to invalidate the input of the palm touch; and
a controller for identifying a pen touch and a palm touch that are simultaneously input, for removing an input corresponding to the palm touch, for processing only the pen touch as an effective input, and for controlling an operation corresponding to the pen touch.

12. The device of claim 11, wherein the controller produces and stores a palm touch identifying reference value according to a user's definition in a palm touch setting mode.

13. The device of claim 12, wherein the controller comprises:
a palm touch processor for detecting an area where a touch is input, for identifying the palm touch and the pen touch, for processing the palm touch as an ineffective input, and for processing the pen touch as an effective input.

14. The device of claim 12, wherein the controller calculates a palm touch value according to the palm touch, compares the calculated palm touch value with the palm touch identifying reference value, and removes an input of the palm touch according to a degree to which the calculated palm touch value matches the palm touch identifying reference value.

15. The device of claim 14, wherein the controller produces pattern information showing the degree to which the calculated palm touch value matches the palm touch identifying reference value, and removes, when the pattern information is equal to or greater than the palm touch invalidating reference value, the input corresponding to the palm touch, and processes the pen touch as an effective input.

16. The device of claim 15, wherein the controller receives, when the pattern information is less than the palm touch invalidating reference value, inputs via the palm touch until the pattern information is equal to the reset palm touch invalidating reference value; and temporarily stores the inputs.

17. The device of claim 12, wherein the controller controls a display unit of the device to display sample information for analyzing a pattern of the user's input.
